(19) United States
(12) Patent Application Publication
(10) Pub. No.: US 2025/0196123 A1
(43) Pub. Date: Jun. 19, 2025

(54) INORGANIC ION EXCHANGE MEDIA AND USE AND METHOD OF MANUFACTURING THE SAME

(71) Applicant: Surfatas Corporation, LLC, Huntersville, NC (US)

(72) Inventors: Arvind S. Patil, Davidson, NC (US); Glenn F. Cueman, Denver, NC (US); Selena Rhodes, Charlotte, NC (US)

(21) Appl. No.: 18/987,191

(22) Filed: Dec. 19, 2024

Related U.S. Application Data
(60) Provisional application No. 63/611,803, filed on Dec. 19, 2023.

(51) Int. Cl. B01J 39/14; B01J 39/02; C02F 1/28; C02F 101/20

(52) U.S. Cl. CPC B01J 39/14; B01J 39/02; C02F 1/281; C02F 2101/20; C02F 2303/22

(57) ABSTRACT

In one aspect, a composition is provided, comprising an ion exchange resin and a binder. In some embodiments, the ion exchange resin may be a synthetic zeolite. A water softener is also provided, comprising a composition comprising an ion exchange resin and a binder. A method for producing the composition is also provided, comprising providing an ion exchange resin and a binder, combining the ion exchange resin and the binder so as to form a homogeneous mixture, combining the homogeneous mixture with water so as to form a wetted mixture, and subjecting the wetted mixture to agglomeration.

### CROSS REFERENCE TO RELATED PATENT APPLICATION

The present patent application/patent claims the benefit of priority of co-pending U.S. Provisional Patent Application No. 63/611,803, filed on Dec. 19, 2023, and entitled “INORGANIC ION EXCHANGE MEDIA AND USE AND METHOD OF MANUFACTURING THE SAME,” the contents of which are incorporated in full by reference herein.

### FIELD

The present invention relates generally to compositions comprising an ion exchange resin, water softeners comprising said composition, and methods of manufacturing the same.

### BACKGROUND

The presence of hard minerals, such as calcium and magnesium, in water results in the formation of hard deposits, known as lime scale. These deposits can clog pipes and coat heating elements, thereby decreasing the effectiveness of nearly all cleaning tasks.

Hard water can be softened using an ion exchange softening process. Ion exchange involves removing the hardness-causing ions (e.g., calcium and magnesium), and replacing them with non-hardness-causing ions.

Currently, the majority of water softeners utilize synthetic strong acid cation exchange (SAC) resin media to remove calcium and magnesium hardness-causing cations. About 90% of all ion exchange resins are based on a functionalized polystyrene-divinylbenzene copolymer. The “building block” used to make this plastic skeleton is a styrene monomer, an aromatic compound also called vinylbenzene. Specifically, synthetic cation exchange resins usually comprise polymerized styrene cross-linked with divinylbenzene.

The activation or functionalization of styrene divinylbenzene copolymers in strongly acidic cation exchange (SAC) styrene divinylbenzene resins is achieved by a sulfonation reaction. During a sulfonation reaction, cross-linked polystyrene divinylbenzene copolymer beads are contacted at high temperature with concentrated sulfuric acid. The resultant product is a polystyrene sulfonate, which is a strong acid:

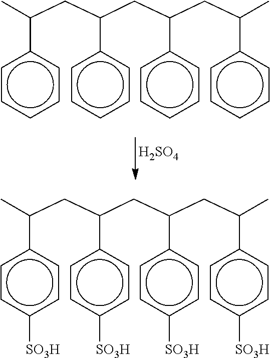

After sulfonation, the resin is washed to remove excess sulfuric acid. This hydration step is a delicate operation, as it causes the resin beads to swell (functional groups are hydrated and thus grow in size). The corresponding osmotic force is considerable, and can result in the beads breaking to pieces if not properly done.

The above reaction produces a resin in hydrogen form. If the product is to be used as a softening resin, it must be converted, in an additional step, to the sodium form. This can be accomplished, for example, with sodium carbonate.

However, styrene divinylbenzene copolymer resins suffer from several significant disadvantages. For instance, SAC resins are prone to oxidative degradation due to attack by dissolved chlorine and chloramine (monochloramine) disinfectants.

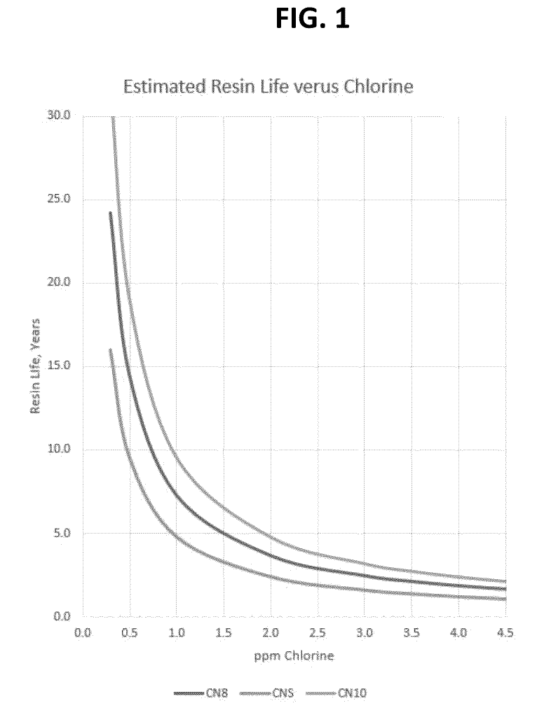

Functionalized copolymer resins (which result in a SAC exchange resin) typically have a DVB cross-linking level of 8% (8 lb. of DVB per 100 lb. styrene monomer during the polymerization reaction). There is a direct correlation between the cross-linking percent and the life of a SAC resin in a softener. However, as shown in FIG. 1, significant degradation occurs regardless of cross-linking level, due to chlorine exposure (in FIG. 1, CNS represents 6% cross-linking; CN8 represents 8% cross-linking, and CN10 represents 10% cross-linking).

The U.S. Environmental Protection Agency mandates addition of about 2 ppm of available chlorine and 3 ppm of chloramine to drinking water for sanitation purposes. At these concentrations, the free chlorine and chloramine will attack the structure of the crosslinking sites of the divinylbenzene copolymer, reducing its effectiveness. This is further exacerbated when the free chlorine level is further increased to the allowable level of 4 ppm during emergencies. Both free chlorine and chloramine (which is used by about 40% of the municipalities) cause harm to styrene divinylbenzene copolymers. Thus, in addition to breaking down and losing their effectiveness with age, SAC resins are susceptible to breakdowns and loss of effectiveness as a result of oxidative degradation caused by chlorine and chloramine.

Additionally, because of their organic nature, SAC resins are subject to bacterial attacks, leading to fouling of the resins. Fouling reduces the cation exchange capacity of the resins, resulting in lower performance of the softener.

Further, SAC resins are also fouled by inorganic contaminants, such as iron, barium and aluminum, which block the cation exchange sites, reducing their capacity to soften.

The above result in leakages of calcium and magnesium (e.g., the cations that cause hardness in water) in the treated water of a water softener. Although a leakage of up to 17 mg/L (1 grain) of calcium and magnesium ions (as calcium carbonate) is permissible, deterioration of SAC resins due to the above-mentioned issues leads to leakage of hardness-causing ions beyond permissible levels. Moreover, once deterioration begins, the above effects cascade and exponentially increase.

### BRIEF SUMMARY

The present invention addresses the disadvantages and shortcomings of previous synthetic cation exchange resins based on styrene di-vinyl benzene chemistry.

In one aspect, a composition is provided, comprising an ion exchange resin, and a binder. In some embodiments, the ion exchange resin is a zeolite. In some embodiments, the ion exchange resin is a synthetic zeolite. In one aspect, the synthetic zeolite is a zeolite of formula M_{X/n}[(AlO₂)_{X}(SiO₂)_{Y}]·zH₂O, wherein M is an exchangeable cation with valency n, x is 2 or more, y is 2 or more, and z represents an amount of water present in voids of said zeolite. In some embodiments, the synthetic zeolite is Zeolite A. In some embodiments, the synthetic zeolite is Zeolite 4A. In some embodiments, the binder is Attapulgite clay.

In one aspect, the composition comprises at least 80 wt. % ion exchange resin, based on the total weight of the composition. In some embodiments, the composition comprises at least 85 wt. % ion exchange resin, based on the total weight of the composition. In some embodiments, the composition comprises at least 5 wt. % binder, based on the total weight of the composition. In some embodiments, the composition comprises 85-95 wt. % ion exchange resin, based on the total weight of the composition. In some embodiments, the composition comprises 5-15 wt. % binder, based on the total weight of the composition.

In another aspect, a water softener is provided, comprising any of the compositions as described above. In some embodiments, the composition is in the shape of beads. In some embodiments, the beads have a bead diameter of 1-2 mm.

A dual system for water softening and heavy metal removal is also provided, comprising a tank comprising any of the compositions described above.

In another aspect, a method for producing a composition is provided, comprising providing an ion exchange resin and a binder, combining the ion exchange resin and the binder so as to form a homogeneous mixture, combining the homogeneous mixture with water so as to form a wetted mixture, and subjecting the wetted mixture to agglomeration. In some embodiments, subjecting the wetted mixture to agglomeration produces particles in the shape of beads. In some embodiments, the method additionally comprises subjecting the particles to sintering and subsequent cooling. In some embodiments, the method also comprises sieving the particles after subjecting the same to sintering and cooling.

These and other embodiments are further described in the following detailed description.

### DETAILED DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals (if any) designate corresponding parts throughout the several views. It should be recognized that these implementations and embodiments are merely illustrative of the principles of the present disclosure, and do not represent all possible embodiments.

FIG. 1 shows cross-linking levels for various prior art SAC resins.

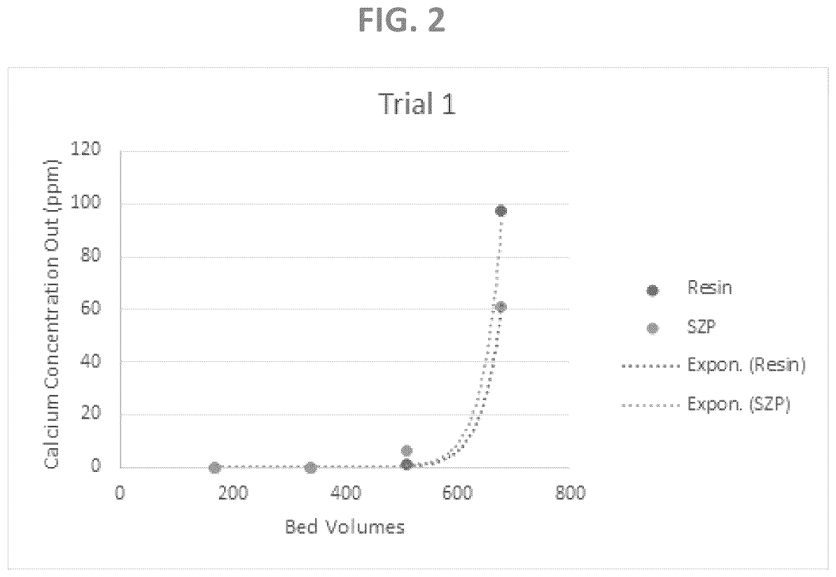

FIG. 2 shows the results of a fixed-bed column test (trial 1).

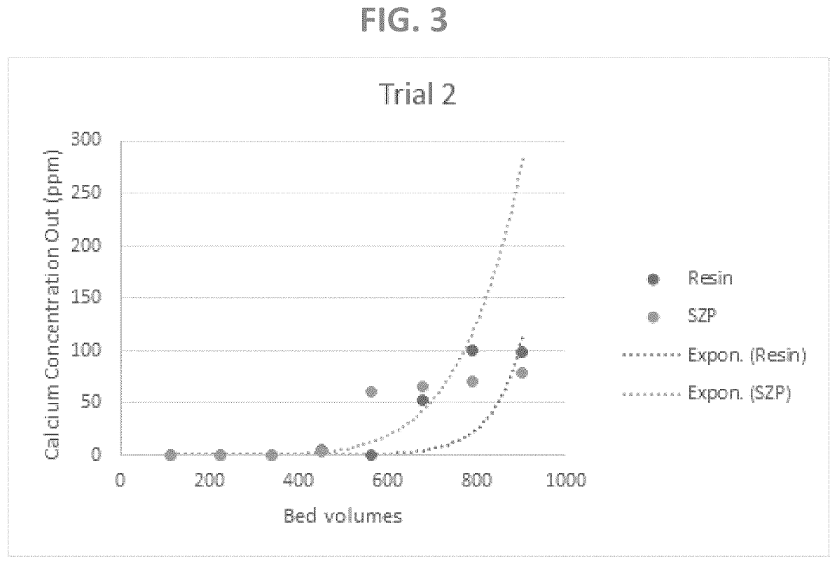

FIG. 3 shows the results of a fixed-bed column test (trial 2).

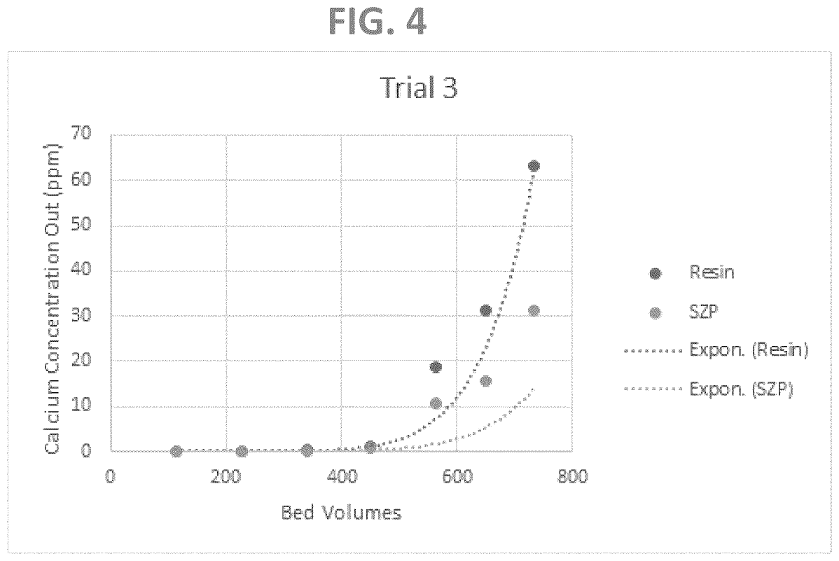

FIG. 4 shows the results of a fixed-bed column test (trial 3).

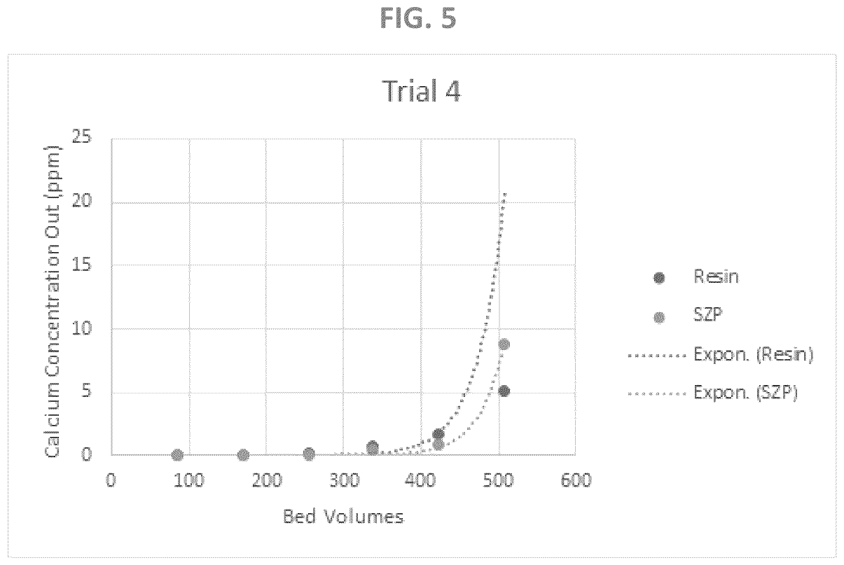

FIG. 5 shows the results of a fixed-bed column test (trial 4).

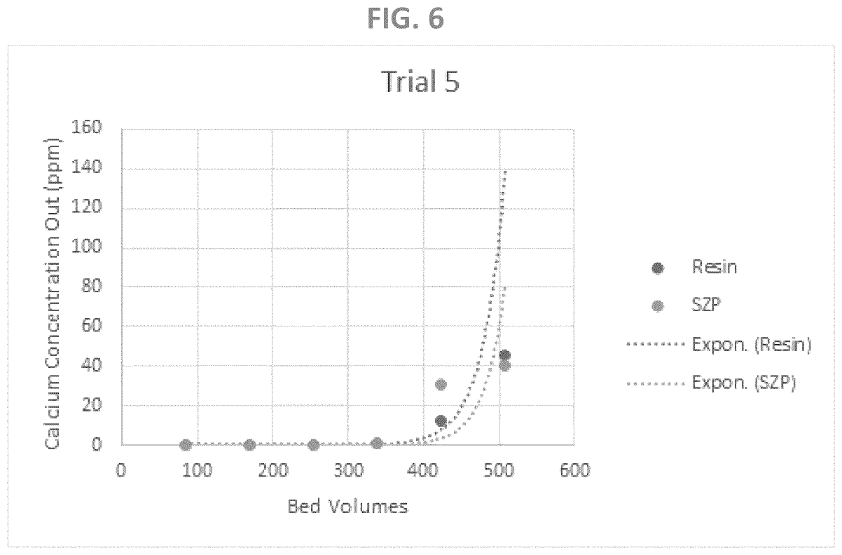

FIG. 6 shows the results of a fixed-bed column test (trial 5).

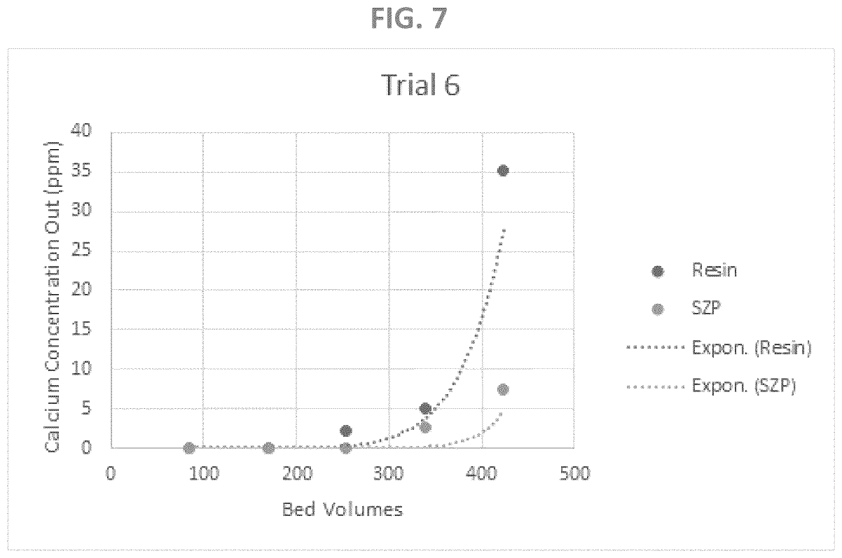

FIG. 7 shows the results of a fixed-bed column test (trial 6).

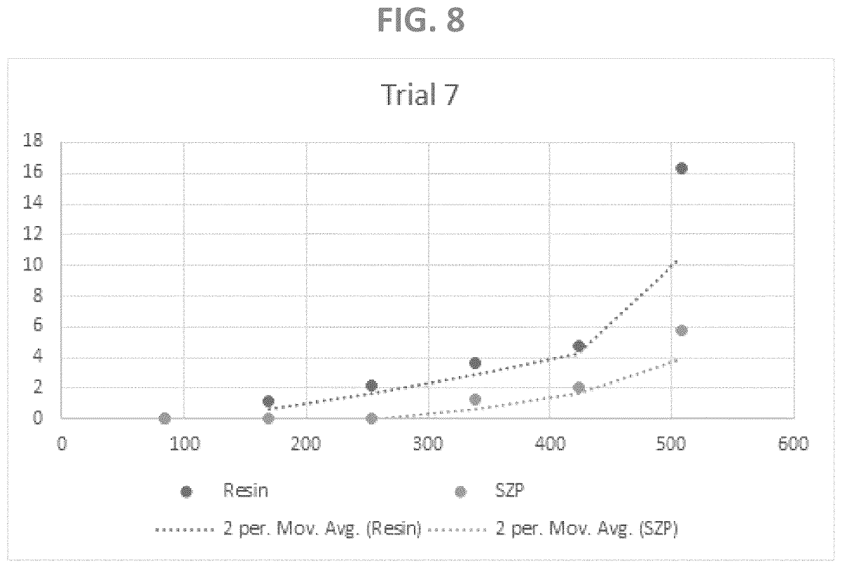

FIG. 8 shows the results of a fixed-bed column test (trial 7).

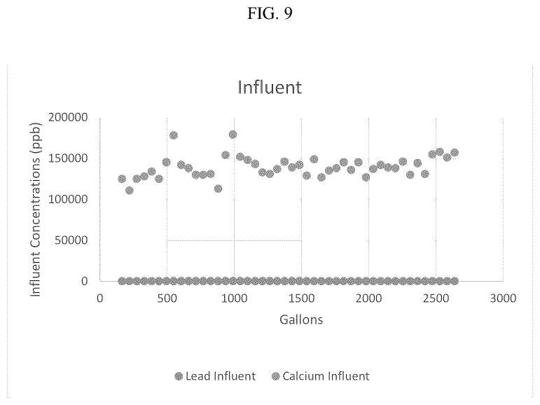

FIG. 9 shows the results of a softening test at an influent flow rate of 2 gpm.

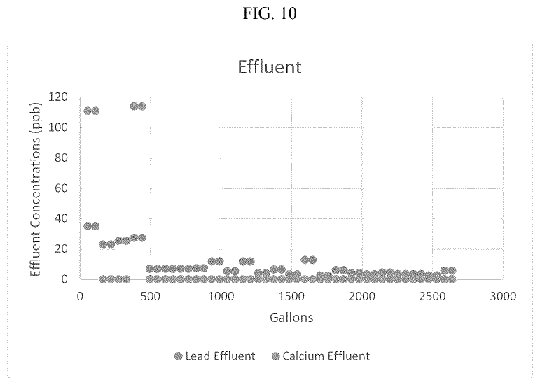

FIG. 10 shows the results of a softening test at an influent flow rate of 2 gpm.

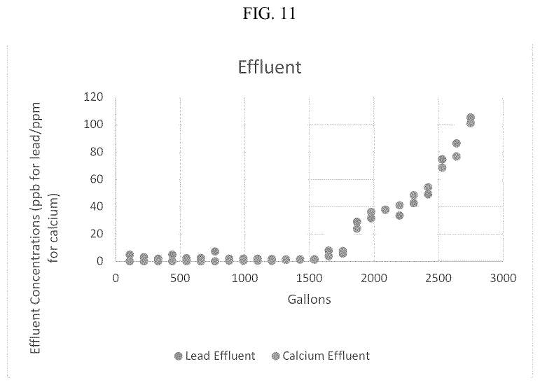

FIG. 11 shows the results of a softening test at an influent flow rate of 4 gpm.

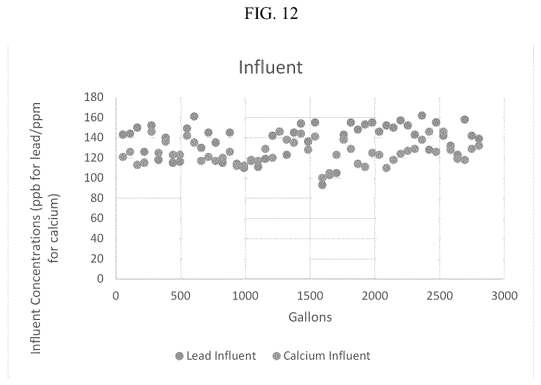

FIG. 12 shows the results of a softening test at an influent flow rate of 4 gpm.

### DETAILED DESCRIPTION

Embodiments described herein may be understood more readily by reference to the following detailed description. It is to be understood that the present invention is not limited to the specific compositions, devices, methods, conditions and/or parameters described and/or shown herein, and that the terminology used herein is for the purpose of describing particular embodiments by way of example only, and is not intended to be limiting. It should be recognized that the embodiments herein are merely illustrative, and not all embodiments are described. Numerous modifications and adaptations will be readily apparent to those of skill in the art without departing from the spirit and scope of the invention.

As used herein, the term “and/or” includes any and all combinations of one or more of the associated listed items.

As used in this application, including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The ranges set forth herein include both the numbers at the end of each range and any and all conceivable numbers therebetween, as that is the very definition of a range. It is therefore to be understood that the ranges and limits mentioned herein include all ranges located within the prescribed limits (i.e., subranges). For example, a range of from “about 100 to about 200” is meant to also include ranges from 110 to 150, 170 to 190, 153 to 162, and 145.3 to 149.6, inter alia. Further, as another example, a limit of “up to about 7” also includes a limit of up to about 5, up to 3, and up to about 4.5, inter alia, as well as any and all ranges within the limit, such as from about 1 to about 5, and from about 3.2 to about 6.5, inter alia, as examples (provided that the minimum amount is at least a detectable or non-zero amount, such that an amount of “up to X” does not include an amount of zero). As another example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9, etcetera.

Unless otherwise indicated, all numbers expressing quantities of ingredients, properties, such as molecular weight, pH, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained. In some cases, the term “about” can be replaced with the term “within 5% of” or “within 1% of.”

As used herein, the terms “comprise”, “comprises”, “containing”; “has”, “have”, “having”; and “includes”, “include” and “including” are open-ended transition terms used to transition from a subject recited before the term to one or more elements recited after the term, where the element or elements listed after the transition term are not necessarily the only elements that make up the subject.

The term weight percent or wt. % means the weight of a given material relative to the weight of a resulting composition which includes the given material. For example, a composition comprising 10 wt. % of a component means that the composition includes 10 parts by weight of the component relative to 100 parts of the total weight of the resulting composition.

Unless otherwise defined, all terms (including technical and scientific terms) used herein have the same meaning as commonly understood by one having ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that a number of techniques, components, and steps are disclosed. Each of these has individual benefit and each can also be used in conjunction with one or more, or in some cases all, of the other disclosed techniques. Accordingly, for the sake of clarity, this description will refrain from repeating every possible combination of the individual steps or components in an unnecessary fashion. Nevertheless, the specification and claims should be read with the understanding that such combinations are entirely within the scope of the invention and the claims.

### I. Compositions

The present invention addresses the disadvantages and shortcomings of previous synthetic cation exchange resins based on styrene di-vinyl benzene chemistry and provides, for the first time, a novel and inventive composition for water softening utilizing zeolites.

In one aspect, a composition comprises an ion exchange resin and a binder.

Any ion exchange resin not inconsistent with the objectives of this disclosure may be employed. In some embodiments, the ion exchange resin is a zeolite. Zeolites are hydrated aluminosilicate minerals made from interlinked tetrahedra of alumina (AlO₄) and silica (SiO₄). They are solids with a relatively open, three-dimensional crystal structure built from the elements aluminum, oxygen, and silicon, with alkali or alkaline-Earth metals (e.g., sodium, potassium, and magnesium) and water molecules trapped in the gaps between them. Zeolites are microporous and crystalline. Chemists have classified approximately 50 natural zeolites, and over 200 synthetic zeolites (see, e.g., Kurzendörfer et. al., “Zeolites in the Environment,” in Detergents in the Environment, New York 1997). A common property of all zeolites is their ion exchange capability. The adsorptive capacity of zeolites in separation processes led to the name “molecular sieve” being used as a synonym for zeolites. However, naturally-occurring zeolites are usually mixed with clays and other minerals, which result in dilution of the content of the zeolite, resulting in significant reductions in the cation exchange capacity thereof (usually as much as half). Furthermore, it is very difficult to maintain the quality and consistency of mined products. For these reasons, the use of zeolites in softening of hard water has not been successful in the past.

In some embodiments, the ion exchange resin is a synthetic zeolite. Synthetically-produced zeolites (molecular sieves), though chemically identical to naturally occurring zeolites (e.g., clinoptilolite, chabazite, erionite, and mordenite) by virtue of being aluminum silicates, differ in their silica to aluminum ratio, which results, in some embodiments, in a higher cation exchange capacity. The present inventors are the first to successfully employ synthetic zeolites for water softening purposes. The use of synthetic zeolites in softeners was not possible until the present invention was developed, despite their much higher exchange capacity, because of the zeolites' particle size of 4-5 micron. Specifically, ideal media for water softening should be granular, round, and approximately 1 mm in diameter. Agglomerating 4-5-micron particles of synthetic zeolites to a 1000-micron particle, in a stable configuration for softening applications, without blinding the ion exchange sites, has not been previously possible. However, the present inventors have now accomplished this, with less than 10-15% reduction in cation exchange capacity.

Any synthetic zeolite not inconsistent with the objectives of this disclosure may be employed. In some embodiments, the synthetic zeolite is a zeolite of formula

M_{X/n}[(AlO₂)_{X}(SiO₂)_{Y}]·zH₂O,

wherein M is an exchangeable cation with valency n, x is 2 or more, y is 2 or more, and z represents an amount of water present in voids of said zeolite. In some embodiments, x=y.

In some embodiments, the synthetic zeolite is Zeolite A (x=y=12, z=27). In some embodiments, the synthetic zeolite is Zeolite 4A (Zeolite NaA). Zeolite 4A comprises 8 cubo-octahedrons linked via 12 cuboids to a cavity, which is referred to as the a-cage. The “windows” (pores) of these cages have a diameter of approximately 0.42 nm (4.2 Angstroms), and can therefore be permeated only by small molecules or ions, while calcium ions diffuse relatively easily into the interstices. Other synthetic zeolites may also be employed, such as Zeolite 3A, Zeolite 5A, Zeolite X, Zeolite Y, and/or Zeolite P.

Any binder not inconsistent with the objectives of this disclosure may be employed. In some embodiments, the binder exhibits temperature stability when exposed to calcination. In some embodiments, the binder also exhibits a cation exchange capacity, such that it minimizes any dilution effects on capacity when combined with the ion exchange resin.

In some embodiments, the binder is Attapulgite clay. Other binders may also be employed, such as Kaolinite clay, Montmorillonite clay, Bentonite clay or mixtures of these. The preferred binder Attapulgite clay was found to have a cation exchange capacity of 0.6 meq/g.

A composition as disclosed herein, in some embodiments, may comprise at least 75 wt. % ion exchange resin, based on the total weight of the composition. In some embodiments, a composition herein comprises at least 80 wt. %, at least 85 wt. %, at least 90 wt. %, or at least 95 wt. % ion exchange resin, based on the total weight of the composition. In some embodiments, the composition comprises 75-99 wt. % ion exchange resin, based on the total weight of the composition. In some embodiments, the composition comprises 75-95 wt. %, 80-99 wt. %, 80-95 wt. %, 85-99 wt. %, 85-95 wt. %, 90-99 wt. %, or 90-95 wt. % ion exchange resin, based on the total weight of the composition.

In some embodiments, the composition comprises at least 1 wt. % binder, based on the total weight of the composition. In some embodiments, the composition comprises at least 5 wt. % or at least 10 wt. % binder, based on the total weight of the composition. In some embodiments, the composition comprises a maximum of 15 wt. % binder, based on the total weight of the composition. In some embodiments, the composition comprises 1-15 wt. %, 5-15 wt. %, or 10-15 wt. % binder, based on the total weight of the composition.

In some embodiments, the composition comprises 85-95 wt. % ion exchange resin, and 5-15 wt. % binder, based on the total weight of the composition.

In some embodiments, the composition comprises additional components besides the ion exchange resin and the binder. Any additional component not inconsistent with the objectives of this disclosure may be employed. For instance, in some embodiments, are antimicrobial agents such as Zinc Zeolites or KDF (Kinetic Degradation Fluxion) added in range of <1 wt. % to up to 5 wt. %.

In some embodiments, a composition herein is in the form of beads. In some embodiments, beads are sieved to a size (diameter) of up to 3 mm. In some embodiments, beads are sieved to a size of up to 2.0 mm, 1.9 mm, 1.8 mm, 1.7 mm, 1.6 mm, or 1.5 mm. In some embodiments, beads are sieved to a size of at least 0.25 mm, at least 0.5 mm, at least 0.6 mm, at least 0.7 mm, at least 0.8 mm, at least 0.9 mm, or at least 1.0 mm. In some embodiments, the beads have a diameter of 0.25 mm-3.0 mm, 0.5-2 mm, 1-2 mm, or 1-1.5 mm (1000-1500 micron).

The present inventors have, for the first time, developed beads of synthetic zeolite which are stable, and strong enough and abrasion resistant enough to withstand water flows of 10-15 GPM across, with minimum erosion. Furthermore, the inventive compositions herein are resistant to biological and chemical attacks. Specifically, it has been confirmed that the presence of as much as 4 ppm chlorine does not affect the performance of compositions as described herein in any way. As a result, the compositions herein can outlive synthetic organic resins, in terms of performance, by many years. Beads in accordance with embodiments herein also exhibit resistance to breakdown (e.g., resistance of the particles in water when subjected to a waterflow of up to 10 GPM across it in a column).

Compositions described herein exhibit higher ion exchange capacity as compared to prior art polystyrene-divinylbenzene compositions. For instance, in some embodiments, compositions as described herein have an ion exchange capacity of 3.21 equivalents/L (71 Kgr/cubic foot). In contrast, the exchange capacity of conventional 10% crosslinked styrene resins is 2 equivalents/L (42 Kgr/cubic feet). As such, compositions as described herein exhibit almost 40% higher capacity (38% higher capacity in some embodiments) than conventional resins. As a result, a water softener tank that is 8×44 (8″ in diameter; 44′ tall), 0.75 cubic feet, in size would have a capacity of 52 Kilo-grains. Similarly, a tank that is 10×54′, 1.5 cubic feet, in size would have a softening capacity of 104 Kilo grains. Due to their higher cation exchange capacity, a mesh containing compositions as described herein would not need frequent regeneration, reducing costs in terms of equipment and materials (e.g., salt usage).

Compositions described herein are effective for other uses, in addition to water softening and/or removal of hardness-causing ions. For instance, in some embodiments, compositions described herein can remove heavy metals from water. In some embodiments, compositions herein can remove lead, cadmium, mercury, manganese, ferrous iron, zinc, nickel, and/or chromium III, among others.

In some embodiments, compositions herein can effectively soften hard water and remove heavy metals simultaneously. The simultaneous removal of heavy metals while softening is an additional innovative aspect of the compositions herein. In one aspect, a dual system for water softening and heavy metal removal is provided, comprising any of the compositions described hereinabove. In some embodiments, the dual system comprises a tank comprising a composition as described above. In some embodiments, the dual system comprises a tank comprising beads, wherein the beads comprise a composition as described above.

In modern softening devices, with the use of electronic microprocessors, there is an automatic regeneration of the softening system based on the known capacity of the media contained in it. Softening is the primary goal, and it determines the point of regeneration. When compositions as described herein are added to a softening device, as a result of each regeneration, the compositions can also be regenerated for the adsorption of heavy metals, creating “virgin” adsorption sites, where adsorption of heavy metals can proceed with maximum efficiency. As a result, in some embodiments, very high heavy metal removal rates (e.g., greater than 90%), and low concentrations of metals in the effluent, can be achieved, simultaneously with water softening, during the softening cycle.

Prior to the present invention, it was necessary to remove any heavy metals prior to softening, using separate point of entry (POE) devices. The ability of compositions herein to simultaneously remove hardness-causing ions and heavy metals is extremely advantageous, as it obviates the use of multiple treatment devices, thereby providing quantifiable savings in terms of manufacturing costs, time, and equipment expenditures.

Compositions as disclosed herein exhibit higher capacity, resistance to degradation due to disinfectants, and are easy to manufacture in large amounts with consistently high quality.

### II. Water Softeners

In another aspect, a water softener is provided. The use of synthetic zeolites in water softeners was not possible prior to the present invention, despite exhibiting higher exchange capacity, due to their particle size of 4-5 microns. Ideal media for a water softener should be granular, round, and approximately 1-1.5 mm (1000-1500 micron) in diameter. Additionally, ideal media should be stable, porous, and free of blinding of ion exchange sites due to the binder. Further, the percentage of binder should be such that it causes minimum reduction in the ion exchange capacity.

The present inventors are the first to produce compositions comprising synthetic zeolites which can be used in water softeners, with only a 10-15% reduction in the cation exchange capacity of the ion exchange resin (synthetic zeolite).

Beads comprising compositions as described in Section I hereinabove are strong enough and abrasion resistant enough to withstand water flows of 10-15 GPM across, with minimum erosion of the beads, and are ideal for use in water softeners. Compositions herein can be readily adopted to modern water softeners equipped with electronic microprocessors for automatic regeneration.

In some embodiments, the water softener comprises an ion exchange resin and a binder. Any ion exchange resin and/or binder disclosed hereinabove in Section I may be employed in a water softener herein.

In some embodiments, a water softener comprises beads comprising the ion exchange resin and binder. In some embodiments, the beads have a diameter of 0.25 mm-3.5 mm. In some embodiments, the beads have a diameter of 0.25 mm-3.0 mm, 0.5-2 mm, 1-2 mm, or 1-1.5 mm (1000-1500 micron).

A water softener described herein may include additional components besides an ion exchange resin and a binder. For instance, catalytic carbon to remove chloramine and volatile organic compounds such as pesticides and pharmaceuticals.

### III. Methods of Producing a Composition

In another aspect, a method for producing a composition is provided. Methods herein can produce the compositions described in Sections I and II hereinabove.

In some embodiments, a method comprises providing an ion exchange resin and a binder, and combining the ion exchange resin and the binder so as to form a homogeneous mixture. Any ion exchange resin and/or binder disclosed hereinabove in Section I may be employed.

In some embodiments, the homogeneous mixture comprises at least 80 wt. %, at least 85 wt. %, at least 90 wt. %, or at least 95 wt. % ion exchange resin, based on the total weight of the composition. In some embodiments, the mixture comprises 75-99 wt. % ion exchange resin, based on the total weight of the mixture. In some embodiments, the mixture comprises 75-95 wt. %, 80-99 wt. %, 80-95 wt. %, 85-99 wt. %, 85-95 wt. %, 90-99 wt. %, or 90-95 wt. % ion exchange resin, based on the total weight of the mixture.

In some embodiments, the homogeneous mixture comprises at least 1 wt. % binder, based on the total weight of the mixture. In some embodiments, the mixture comprises at least 5 wt. % or at least 10 wt. % binder, based on the total weight of the mixture. In some embodiments, the mixture comprises 1-15 wt. %, 5-15 wt. %, or 10-15 wt. % binder, based on the total weight of the mixture.

In some embodiments, the homogeneous mixture comprises 85-95 wt. % ion exchange resin, and 5-15 wt. % binder, based on the total weight of the mixture. In some embodiments, additional components can be added to the homogeneous mixture.

In some embodiments, the homogeneous mixture is mixed with a sufficient amount of water so as to form a wetted mixture. In some embodiments, up to 40 wt. % water, based on weight of the solids, can be added so as to form a wetted mixture. In some embodiments, up to 25 wt. % or up to 20 wt. % water can be added. In some embodiments, at least 5 wt. % water can be added. In some embodiments, at least 10 wt. %, or at least 15 wt. % water are added. In some embodiments, 5-25 wt. %, 5-20 wt. %, 10-25 wt. %, 10-20 wt. %, 15-25 wt. %, or 15-20 wt or 30-40 wt % of water are added.

In some embodiments, the wetted mixture is subjected to agglomeration. In some embodiments, agglomeration is achieved in an agglomeration drum. In some embodiments, subjecting the wetted mixture to agglomeration causes an increase in the particle size of the agglomerate. In some embodiments, subjecting the wetted mixture to agglomeration produces particles in the shape of beads.

In another embodiment the wetted mixture is subjected to agglomeration. In some embodiments, the agglomeration is achieved in a Fluidized Bed reactor.

In some embodiments, beads formed after subjecting the wetted mixture to agglomeration are subjected to sintering. In some embodiments, sintering is conducted at temperatures of 700° C. to 1100° C. In some embodiments, sintering is conducted at 800° C., 900° C., 1000° C., 1100° C.

In some embodiments, after sintering, beads are subjected to cooling by spraying or misting with water.

In some embodiments the sintered beads are subjected to rehydration of bead by about 18% moisture.

In some embodiments, once the beads are cooled, and or rehydrated, they are sieved. In some embodiments, beads are sieved to a size (diameter) of up to 3 mm. In some embodiments, beds are sieved to a size of up to 2.0 mm, 1.9 mm, 1.8 mm, 1.7 mm, 1.6 mm, or 1.5 mm. In some embodiments, beads are sieved to a size of at least 0.25 mm, at least 0.5 mm, at least 0.6 mm, at least 0.7 mm, at least 0.8 mm, at least 0.9 mm, or at least 1.0 mm. In some embodiments, the beads have a diameter of 1-1.5 mm (1000-1500 micron).

### EXAMPLES

Some additional, non-limiting examples are provided below. The following should not be construed as limiting the disclosed invention in any manner, and are merely illustrative implementations and embodiments of the principles of the present disclosure.

### Example 1

Comparative fixed-bed column experiments were conducted in laboratory conditions to determine the effects of chlorine on various compositions. Specifically, softening trials were conducted in column measurements between a styrene DVB resin (Gen Tech-C108) and a composition according to the present disclosure, comprising 85 wt. % synthetic Zeolite 4A and 15 wt. % Attapulgite clay, based on the total weight of the composition (hereinafter “Inventive Composition”).

For purposes of this experiment, 135.0 g of Gen Tech-C108 were added to a column (bed volume=170 ml). Separately, 134.1 g of the Inventive Composition were added to another column (bed volume=170 ml). Influents comprising 200 ppm of CaCO₃ (11.7 grains/gallon hardness) and 1 ppm of chlorine were passed through the columns at 40 ml/minute, with an empty-bed contact time (EBCT) of 4.25 minutes. After each breakthrough, the columns were regenerated with saturated NaCl, washed free of NaCl using tap water, and challenged with the same influent as described above. A total of 7 trials were conducted, each with approximately 800 bed volumes.

The effluents were analyzed for calcium concentrations. The reason for this approach is that calcium concentrations remain at “non-detect” levels for many bed volumes, and do not increase until saturation of sites at breakthrough occurs. The results are shown in FIGS. 2-8.

As shown in FIGS. 2-8, the organic styrene DVB resin started losing capacity (breakthrough) at earlier bed volumes, whereas the Inventive Composition maintained its capacity. The Inventive Composition exhibited less fouling and degeneration as compared to the organic styrene resin, even after 7 successive regenerations.

### Example 2A

Water softening trials were conducted, using a Lancaster 7-LX-75B tank in manual mode. A volume of 0.6 cubic feet of the Inventive Composition (85 wt. % Zeolite 4A; 15 wt. % Attapulgite clay) was added to the tank (it is noted that, due to differences in bulk density, 0.6 cubic feet were added in order to keep adequate headspace). As required by NSF Standard 44, which establishes minimum requirements for the certification of cation exchange water softeners, the softening capacity of the tank was determined, using 342 mg/L of CaCO₃ (20 grain) in the influent at half (2 gpm) the specified flow rate of 4 gpm (the minimum required for POE by the NSF standard).

As discussed above, the Inventive Composition has an ion exchange capacity of 3.21 equivalents/L (71 Kgr/cubic foot). Based on a 3.21 equivalent/L cation exchange capacity, and the above flow and concentration of the influent, the softening capacity of 2600 gallons was calculated. FIGS. 9 and 10 show the results of the softening tests. As shown in FIGS. 9 and 10, the Inventive Composition reduced calcium levels to “non-detect” level, which are much lower than the permissible 17.1 mg/L level.

### Example 2 B

In addition to the water softening trials discussed in Example 2A above, lead removal tests were conducted by adding 150 ppb of lead to the calcium solution (volume 2600 gallons). The results are also shown in FIGS. 9 and 10. As shown in FIGS. 9 and 10, the Inventive Composition reduced lead levels to 5 ppb or less, which is the required amount per NSF Standard 53.

### Example 2 C

Examples 2A and 2B were repeated at the conditions discussed above, except that an influent flow rate of 4 gpm was employed (instead of the 2 gpm flow rate employed in Examples 2A and 2B). The results are shown in FIGS. 11 and 12. As shown in FIGS. 11 and 12, the Inventive Composition simultaneously removed both calcium (hardness-causing ion) and lead (heavy metal), even at twice the flow rate.

### Example 3

Tests were conducted in order to determine the cation exchange capacity of the Inventive Composition described above (85 wt. % Zeolite A; 15 wt. % Attapulgite clay).

First, the equilibrium saturation lead capacity was determined as follows: A lead stock solution having 500 mg/L (ppm) concentration (5 meq/L) of lead was prepared. 100 mL of the solution was added to a 250 ml beaker, along with 0.1 g of the Inventive Composition and the beaker was placed on an automated shaker at 150 rpm for 24 hours. The solution was allowed to settle down for about 1 hr. Using a 1.0- or 1.2-micron syringe filter, the supernatant was filtered. The lead concentration of the filtered supernatant was measured, using either EPA Method 200.8 or EPA Method 200.9.

Above mentioned experiment was repeated, this time using 0.1 g of only the Attapulgite clay binder (Sample B-80 L-18-266 clay) to determine the cation exchange capacity of binder Attapulgite clay.

To determine the lead capacity, the following formula was used:

$$( Concentration of Original Solution -$$

$$Concentration of Filtered Supernatant ) \times$$

$$0.1 / ( Quantity of Media in Grams ) =$$

$$Quantity of lead ( mg ) removed per gram of media ( mg / g ) .$$

It is noted that the obtained value can be converted to milliequivalents per gram by dividing the equivalent weight of lead (which is done by dividing the molecular weight of lead (207.2) by its valence (2), which equals 103.6).

The procedure was then repeated to determine the saturation cation exchange capacity for each of the heavy metals in the table below, by equilibrating the known weight of the Inventive Composition with 5 meq/L of the respective cation for 24 hours, and determining the reduction in the supernatant solution, expressing it as meq/g (the adsorption capacity of that particular heavy metal cation). Table 1 below shows the results.

TABLE 1

| Heavy Metal | Meq/g |
|---|---|
| Lead | 5 |
| Mercury | 0.83 |
| Cadmium | 4.05 |
| Chromium III | 4.05 |
| Zinc | 5.41 |
| Nickel | 4.02 |
| Manganese | 4.15 |
| Iron II | 3.19 |
| Iron III | 0.07 |

### Example 4A—Bead Production

A homogeneous mixture of 75 lb. of Attapulgite clay and 475 lb. of synthetic zeolite 4A was prepared in a cement mixer. After the initial mixing, when the Attapulgite clay and zeolite 4A became homogeneous, a total of 15-20 wt. % water (based on the total weight of the solids) was added in small increments so that the mixture became tacky. The moisture content at this stage was approximately 15%-30%.

Batches of the wetted mixture were transferred to an agglomerating drum through a raw material feed chute. Agglomeration drums work by tumbling material in a rotating drum in the presence of a binding agent. The binding agent causes the fines to become tacky and allows additional fines to be picked, forming agglomerates by a process of coalescence. The tumbling action helps to round the agglomerates to a spherical shape, thereby creating a homogeneous mixture.

Initially, the agglomerating drum was loaded with the wetted mixture to approximately 2% to 4% of the drum volume. The rotating drum was turned at a speed of 2-3 RPM until the mixture began to agglomerate and increase in size. Additional quantities of the wetted mixture were added after 1-2 hours of tumbling. Continued tumbling caused a further increase in the size of the agglomerates. The process was continued until the particle size of the agglomerate reached 2-3 mm in size. Once this size was reached, the rotating drum was tumbled for another 2 hours, using an exhaust to remove moisture and consolidate the particle size (at this stage, heat may also be added in order to hasten the consolidation process). After the above steps are completed, the particles were spherical beads having a size of about 2 to 2.5 mm, and were stable enough to be discharged into trays.

Trays were loaded with the particles/beads, put into an oven, and subjected to a sintering process at 900° C. The trays were cooled and lightly sprayed with water to wet the particles to gain in weight of about 18%, which caused an increase in the temperature, due to the heat of wetting. Once the beads were cooled, they were sieved to a size (diameter) of approximately 1 to 1.5 mm.

The cation exchange capacity of the cooled and sieved beads was determined by conventional methods, and compared with the cation exchange capacity of original 4-micron samples of synthetic zeolite 4A. It was determined that there was only a 10%-15% reduction in the cation exchange capacity of the inventive beads as compared to 4-micron beads.

Table 2 below shows the particle size distributions of the obtained beads. As shown in Table 2, 80% of the exemplary beads according to embodiments herein had a size in the range between 0.6 to 1.4 mm (between 14 to 30 mesh). In the below table, tare refers to the weight of a pan the exemplary beads are placed for weighing, while gross refers to the weight of the pan and the exemplary beads.

TABLE 2

| | Particle | | Return | Tare | Gross | Applied wt. |
|---|---|---|---|---|---|---|
| Runs | Size | | Sample | (grams) | (grams) | (grams) |
| Mesh | | | | | | 201.38 |
| 6 | 3.4 | mm | 0.0% | 523.5 | 523.46 | |
| 6 × 8 | 3.4-2.4 | mm | 0.0% | 435.1 | 435.2 | |
| 8 × 10 | 2.4-2 | mm | 0.6% | 458.47 | 459.76 | |
| 10 × 12 | 2-1.7 | mm | 1.7% | 426.92 | 430.29 | |
| 12 × 14 | 1.7-1.4 | mm | 4.2% | 455.52 | 464.02 | |
| T4 × 16 | 1.4-1.2 | mm | 6.2% | 337.25 | 349.74 | |
| 16 × 18 | 1.2-1 | mm | 16.4% | 405.15 | 438.19 | |
| 18 × 20 | 1-0.8 | mm | 14.9% | 348.81 | 378.91 | |
| 20 × 25 | 0.8-0.7 | mm | 24.0% | 361.64 | 409.93 | |
| 25 × 30 | 0.7-0.6 | mm | 18.5% | 534.87 | 572.21 | |
| 30 × 35 | 0.6-0.5 | mm | NA | | | |
| 35 × 40 | 0.5-0.4 | mm | 13.3% | 316.34 | 343.06 | |
| −60 | <0.25 | mm | 0.0% | 245.39 | 245.39 | |
| Total | | | 99.9% | | | |

The Mesh numbers in Table 2 are US Sieve Mesh Numbers that correspond to pore openings. These sieves with various openings are staked going from coarser to finer openings, on a tapping machine which shakes the assembly. The test sample is put on the top sieve and the tapping machine shifts the material according to the size of the sieve opening. For instance, Mesh 6 has the opening of 4 mm and mesh 8 has the opening of 2.36 mm and 35 mesh has the opening of 0.425 mm. The material retained on top of each screen is weighed as a Percentage of total sample weight and are assigned the size of the mesh on top of which it is collected. In the Table 2, under the column—particle size—are the openings or the particle sizes denoted.

### Example 4B—Resistance to Breakdown

1 g of beads in accordance with Example 4A hereinabove were placed in a beaker, and 100 ml of distilled water was added thereto. The beads were covered with a plastic film cover, and placed in a rotary shaker, where they were shaken at 150 RPM for 48 hours. At the 24-hour and 48-hour mark, the shaking was interrupted/stopped, and the supernatant solution was drawn out by a pipette and measured for transmittance in a conventional manner. The results are shown in Table 3 below.

TABLE 3

| | % Transmittance after | % Transmittance after |
|---|---|---|
| Sample | 24 hr. | 48 hr. |
| Zeolite 4A bead | 98.6% | 97.6% |

As is known in the art, when there is an erosion in the structure of a bead, the transmittance thereof decreases due to the suspension of fine particles in the supernatant solution. The data in Table 3 shows that the novel Zeolite 4A beads in accordance with embodiments herein exhibited both remarkable stability and wet strength. These results were also achieved when the beads were used as a component of a water softener composition.

1. A composition comprising:
an ion exchange resin; and
a binder.

2. The composition of claim 1, wherein the ion exchange resin is a zeolite.

3. The composition of claim 2, wherein the ion exchange resin is a synthetic zeolite.

4. The composition of claim 3, wherein the synthetic zeolite is a zeolite of formula
M_{X/n}[(AlO₂)_{X}(SiO₂)_{Y}]·zH₂O,
wherein M is an exchangeable cation with valency n, x is 2 or more, y is 2 or more, and z represents an amount of water present in voids of said zeolite.

5. The composition of claim 3, wherein the synthetic zeolite is Zeolite A.

6. The composition of claim 3, wherein the synthetic zeolite is Zeolite 4A.

7. The composition of claim 1, wherein the binder is Attapulgite clay.

8. The composition of claim 1, wherein the composition comprises at least 80 wt. % ion exchange resin, based on the total weight of the composition.

9. The composition of claim 1, wherein the composition comprises at least 85 wt. % ion exchange resin, based on the total weight of the composition.

10. The composition of claim 9, wherein the composition comprises 85-95 wt. % ion exchange resin, based on the total weight of the composition.

11. The composition of claim 9, wherein the composition comprises at least 5 wt. % binder, based on the total weight of the composition.

12. The composition of claim 1, wherein the composition comprises:
85-95 wt. % ion exchange resin; and
5-15 wt. % binder,
based on the total weight of the composition.

13. A water softener comprising the composition of claim 1.

14. The water softener of claim 13, wherein the composition is in the shape of beads.

15. The water softener of claim 14, wherein the beads have a bead diameter of 1-2 mm.

16. A dual system for water softening and heavy metal removal, comprising a tank comprising the composition of claim 1.

17. A method for producing a composition, said method comprising:
providing an ion exchange resin and a binder;
combining the ion exchange resin and the binder so as to form a homogeneous mixture;
combining the homogeneous mixture with water so as to form a wetted mixture; and
subjecting the wetted mixture to agglomeration.

18. The method of claim 17, wherein subjecting the wetted mixture to agglomeration produces particles in the shape of beads.

19. The method of claim 18, further comprising subjecting the particles to sintering and subsequent cooling.

20. The method of claim 19, further comprising sieving the particles after subjecting the same to sintering and cooling and rehydrating.
